(19) United States
(12) Patent Application Publication
(10) Pub. No.: US 2017/0274828 A1
(43) Pub. Date: Sep. 28, 2017

(54) RUNNING BOARD ASSEMBLY HAVING MULTIPLE STEP PADS

(71) Applicant: Ford Global Technologies, LLC, Dearborn, MI (US)

(72) Inventors: David Woodhouse, Troy, MI (US); Earl Clyde Lucas, JR., Southfield, MI (US); Jaewoo Chang, Novi, MI (US)

(73) Assignee: Ford Global Technologies, LLC

(21) Appl. No.: 15/399,178

(22) Filed: Jan. 5, 2017

Related U.S. Application Data
(60) Provisional application No. 62/312,138, filed on Mar. 23, 2016.

(51) Int. Cl. B60R 3/02; B60R 3/00

(52) U.S. Cl. CPC B60R 3/02; B60R 3/002

(57) ABSTRACT

A running board assembly of a vehicle is disclosed herein. A deployment mechanism is movable between a retracted position and an extended position. A plurality of step pads are coupled to the deployment mechanism and are each movable between an undeployed position and a deployed position. When the plurality of step pads are each in the deployed position and the deployment mechanism is in the extended position, the plurality of step pads are arranged as a stairway leading up to an entryway of the vehicle.

### CROSS-REFERENCE TO RELATED APPLICATION

This application claims benefit from U.S. Provisional Application No. 62/312,138, which was filed on Mar. 23, 2016, entitled “RUNNING BOARD ASSEMBLY HAVING MULTIPLE STEP PADS,” the entire disclosure of which is hereby incorporated by reference.

### FIELD OF THE INVENTION

The present invention generally relates to running board assemblies of a vehicle and more particularly relates to running board assemblies that are movable between a stowed position and a use position.

### BACKGROUND OF THE INVENTION

Running board assemblies have long been used to assist users in entering or exiting a vehicle having a high clearance. However, conventional running board assemblies typically include one step pad located at a predetermined height relative to a ground surface. As such, a user who isn't surefooted may still be hindered when attempting to enter or exit the vehicle.

### SUMMARY OF THE INVENTION

According to one aspect of the present invention, a running board assembly of a vehicle is disclosed. A deployment mechanism is movable between a retracted position and an extended position. A plurality of step pads are coupled to the deployment mechanism and are each movable between an undeployed position and a deployed position.

According to another aspect of the present invention, a running board assembly of a vehicle is disclosed. A deployment mechanism is movable between a retracted position and an extended position. A plurality of step pads are coupled to the deployment mechanism and are each movable between an undeployed position and a deployed position. The running board assembly is in a use position when each of the plurality of step pads are in the deployed position and the deployment mechanism is in the extended position. The running board assembly is in a stowed position when each of the plurality of step pads are in the undeployed position and the deployment mechanism is in the retracted position.

According to yet another aspect of the present invention, a running board assembly of a vehicle is disclosed. A deployment mechanism is movable between a retracted position and an extended position. A plurality of step pads are coupled to the deployment mechanism and are each movable between an undeployed position and a deployed position. When the plurality of step pads are each in the deployed position and the deployment mechanism is in the extended position, the plurality of step pads are arranged as a stairway leading up to an entryway of the vehicle.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a side perspective view of a vehicle having a running board assembly deployed to a use position;

FIG. 2 is a side view of the vehicle and the running board assembly shown in FIG. 1;

FIG. 3 is a top view of the vehicle and the running board assembly shown in FIG. 1;

FIG. 4 is an enlarged view of area IV shown in FIG. 3;

FIG. 5 is side perspective view of the vehicle, wherein the running board assembly is being returned to a stowed position;

FIG. 6 is an enlarged view of area VI shown in FIG. 5; and

FIG. 7 is a side perspective view of the vehicle, wherein the running board assembly is in the stowed position.

### DETAILED DESCRIPTION OF THE PREFERRED EMBODIMENTS

As required, detailed embodiments of the present disclosure are disclosed herein. However, it is to be understood that the disclosed embodiments are merely exemplary of the disclosure that may be embodied in various and alternative forms. The figures are not necessarily to a detailed design and some schematics may be exaggerated or minimized to show function overview. Therefore, specific structural and functional details disclosed herein are not to be interpreted as limiting, but merely as a representative basis for teaching one skilled in the art to variously employ the present disclosure.

Additional features and advantages of the invention will be set forth in the detailed description which follows and will be apparent to those skilled in the art from the description or recognized by practicing the invention as described in the following description together with the claims and appended drawings.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

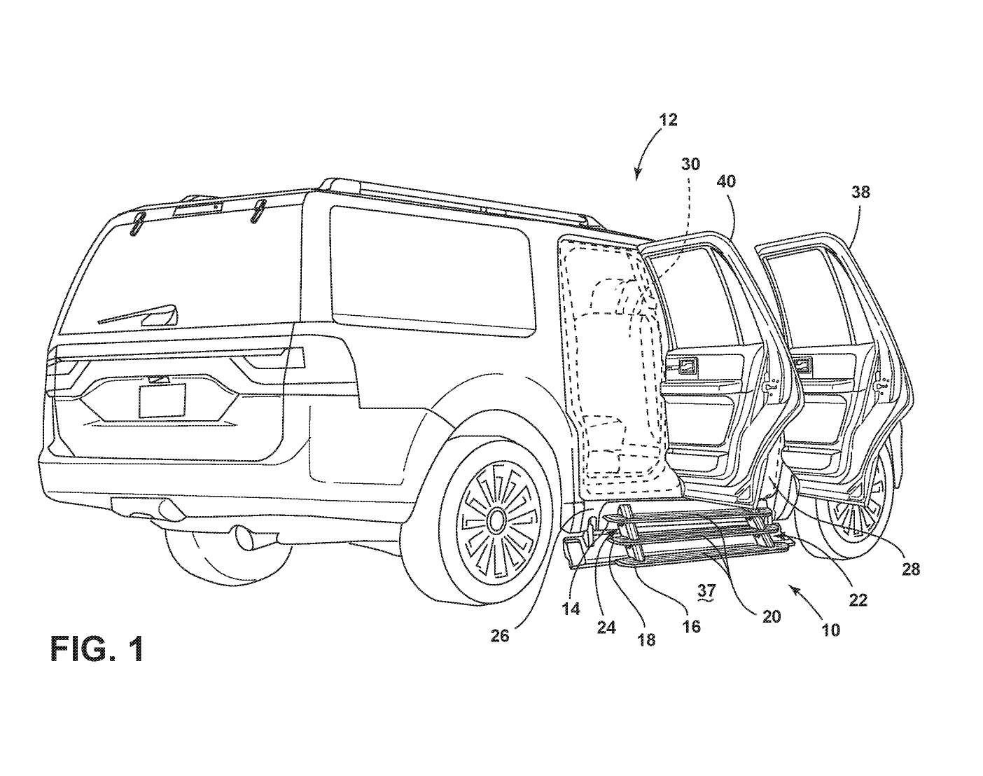

Referring to FIGS. 1-7, reference numeral 10 generally designates a running board assembly of a vehicle 12. For purposes of illustration, the vehicle 12 is exemplarily shown embodied as a sports utility vehicle. However, it is contemplated that the running board assembly 10 may be similarly provided in trucks, vans, or any other vehicle type that typically has a high clearance relative to the ground. With respect to the illustrated embodiment, the running board assembly 10 includes a plurality of step pads, exemplarily shown as a proximal step pad 14, a distal step pad 16, and at least one intermediate step pad 18. For purposes of simplicity, the proximal, distal, and at least one intermediate step pads 14, 16, 18 are collectively referred to herein as “the step pads.”

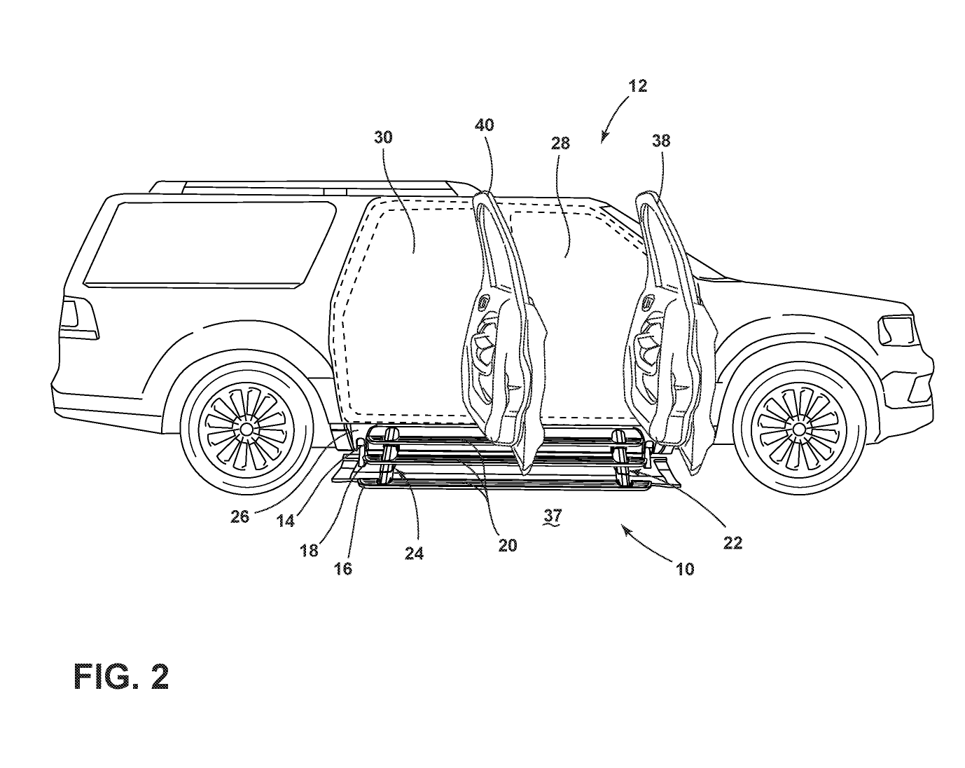

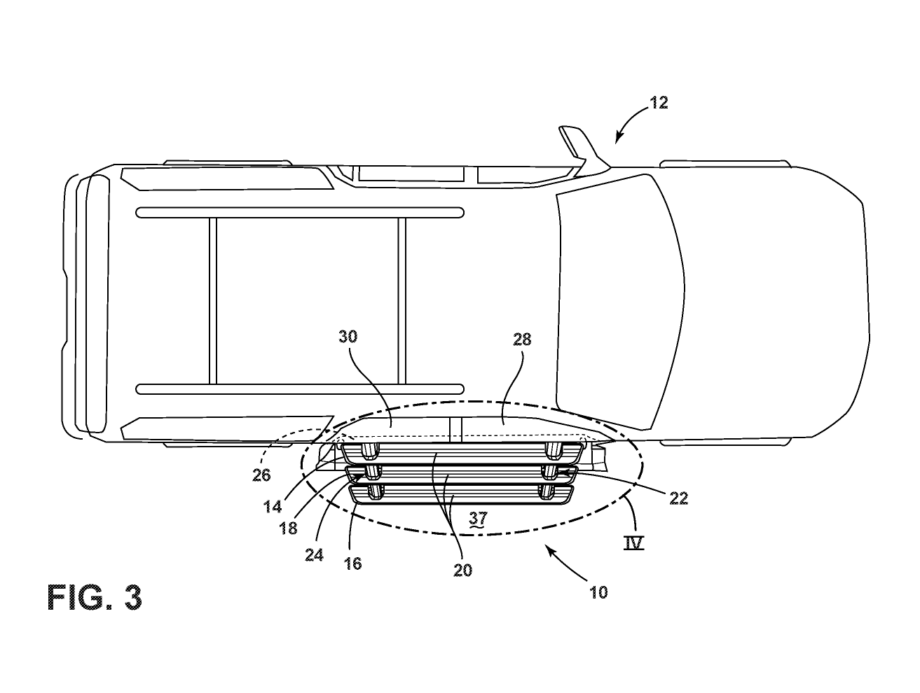

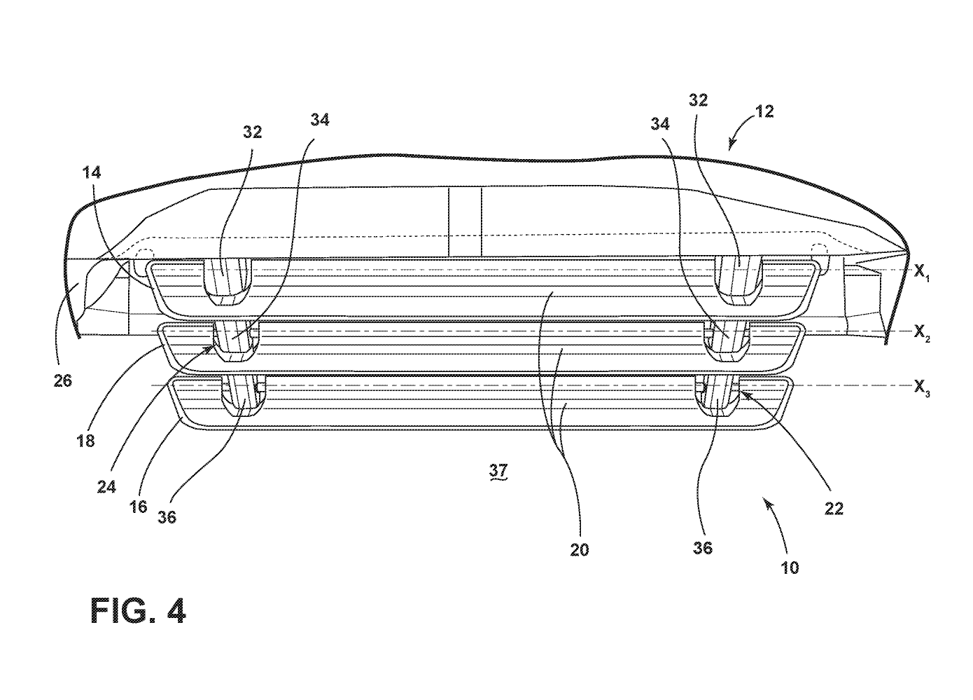

With reference to FIGS. 1-4, the running board assembly 10 is generally arranged in a use position. In the present embodiment, the step pads are each illustrated in a deployed position, wherein a top side 20 of each step pad faces in a general upward direction. As shown, the step pads are coupled to a deployment mechanism, which may be embodied as a pair of telescoping arms 22, 24 that are operable to move in concert. In the present embodiment, the telescoping arms 22, 24 are shown in an extended position. More specifically, the telescoping arms 22, 24 are fully extended at a downward angle from a side structure 26 of the vehicle 12. The side structure 26 may correspond to a portion of the vehicle frame and is generally shown located below a first entryway 28 of a front passenger compartment and a second entryway 30 of a rear passenger compartment. As shown in FIG. 4, the proximal step pad 14 is pivotally coupled to an upper section 32 of each telescoping arm 22, 24 about pivot axis X₁, which generally extends longitudinally with respect to the proximal step pad 14. The upper section 32 of each telescoping arm 22, 24 is static and may be secured to the side structure 26 or partially inserted therethrough and otherwise mounted to the vehicle 12. Each upper section 32 is sized to be able to at least partially sheath a retractable intermediate section 34 of the respective telescoping arm 22, 24 and to which the at least one intermediate step pad 18 is pivotally coupled about pivot axis X₂, which generally extends longitudinally with respect to the at least one intermediate step pad 18. Similarly, each intermediate section 34 is sized to be able to at least partially sheath a retractable lower section 36 of the respective telescoping arm 22, 24 and to which the distal step pad 16 is pivotally coupled about pivot axis X₃, which generally extends longitudinally with respect to the distal step pad 16. As shown, the step pads may be generally planar shaped and may be similarly constructed from a variety of materials known in the art. Additionally, the step pads may be similarly dimensioned to afford easy ingress and egress to and from the first and second entryways 28, 30 when corresponding doors 38 and 40 are in an open position as shown in FIGS. 1 and 2. For purposes of clarity, doors 38 and 40 have been omitted in FIGS. 3 and 4.

With continued reference to FIGS. 1-4, the step pads are shown arranged as a stairway leading up to entryways 28 and 30 of the vehicle 12 when telescoping arms 22, 24 are in the extended position and each of the step pads are in the deployed position. In such an arrangement, the step pads are staggered relative to one another and the step pads are each located at a uniquely associated height relative to a ground surface 37. With respect to the illustrated embodiment, the proximal step pad 14 is located at a shortest distance to the vehicle 12 whereas the distal step pad 16 is located at a farthest distance from the vehicle 12. The at least one intermediate step pad 18 is located relative to the vehicle 12 at a distance between the shortest distance and the farthest distance. Additionally, the proximal step 14 is located at a farthest distance relative to the ground surface 37 whereas the distal step pad 16 is located at a shortest distance relative to the ground surface 37. The at least one intermediate step pad 18 is located at an intermediate distance relative to the ground surface 37, the intermediate distance being between the shortest distance and the farthest distance. Accordingly, when a passenger desires to enter the vehicle 12 through either the first or second entryway 28, 30, the passenger can step up the step pads along an incline, beginning with the distal step pad 16 and ending with the proximal step pad 14. Conversely, when a passenger desires to exit the vehicle 12 from via either the first or second entryway 28, 30, the passenger steps down the step pads along a decline, beginning with the proximal step pad 14 and ending with the distal step pad 16.

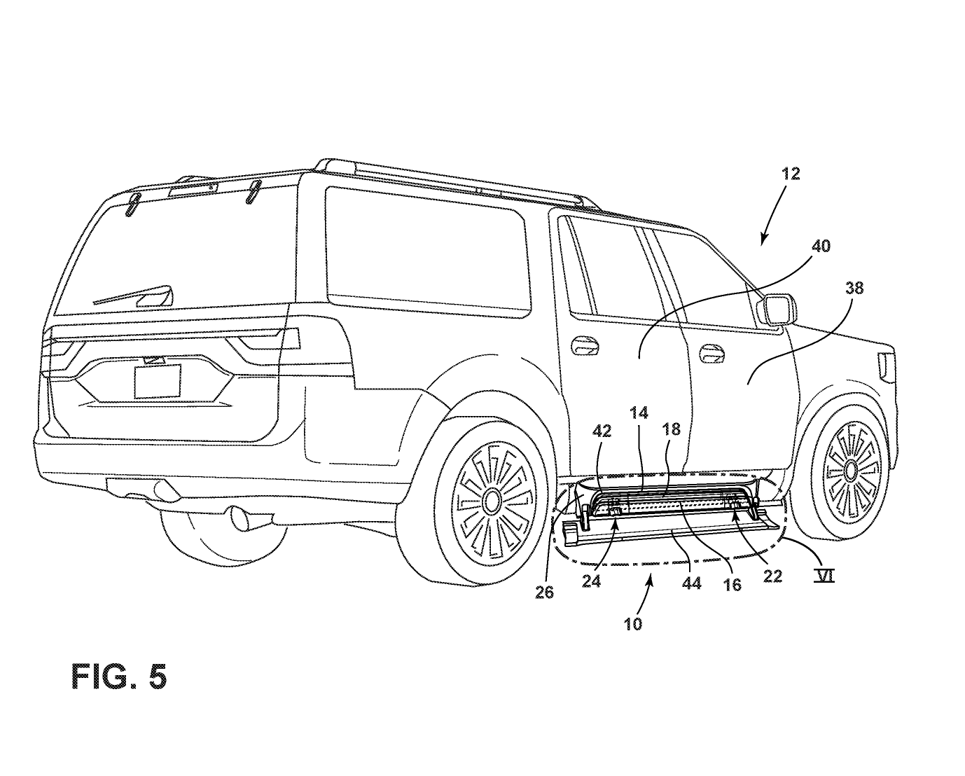

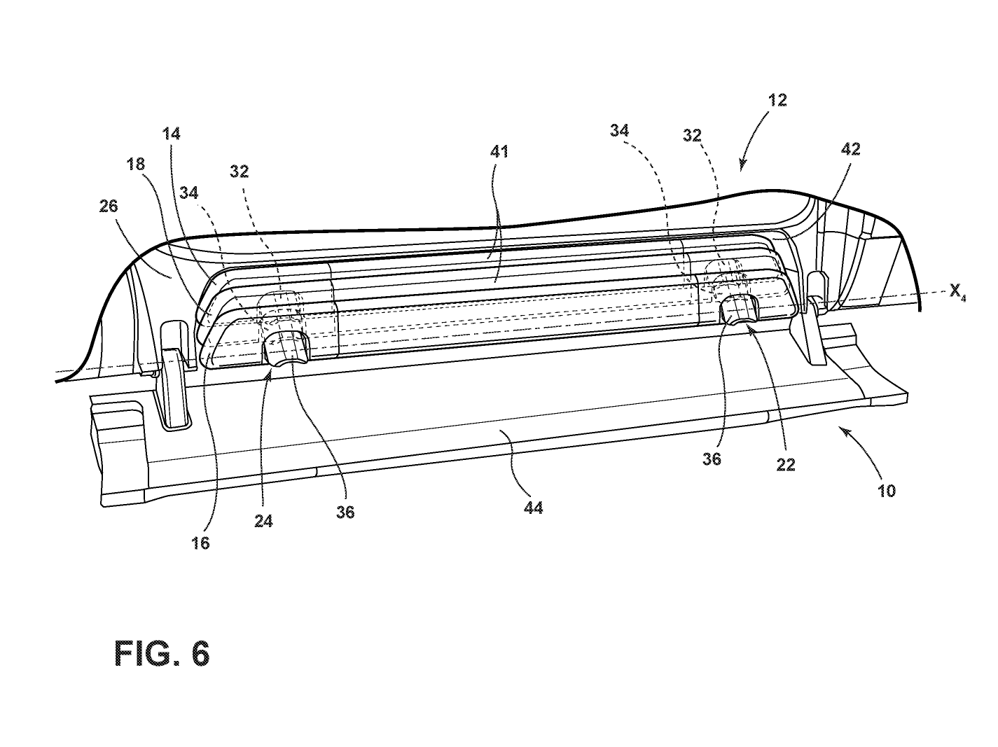

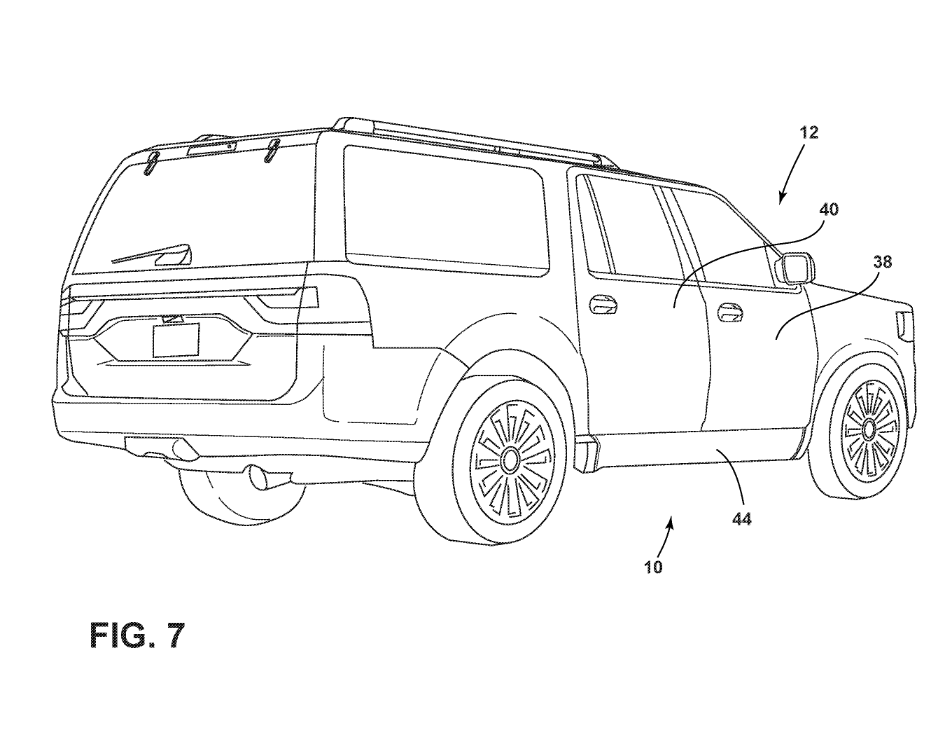

Referring now to FIGS. 5 and 6, the step pads are illustrated in the undeployed position and the telescoping arms 22, 24 are illustrated in a retracted position. As shown, each step pad is generally upright such that the top side 20 of each step pad generally faces towards the vehicle 12. In the present embodiment, the step pads collectively define a stacked arrangement where the step pads are slightly offset from one another. In such an arrangement, the top side 20 of the proximal step pad 14 abuts with the side structure 26. Also, the top side 20 of the at least one intermediate step pad 18 partially abuts an underside 41 (FIG. 6) of the proximal step pad 14 as a result of each intermediate section 34 having been at least partially retracted into the upper section 32 of the respective telescoping arm 22, 24. Further, the top side 20 of the distal step pad 16 partially abuts the underside 41 (FIG. 6) of the at least one intermediate step pad 18 as a result of each lower section 36 having been at least partially retracted into the intermediate section 34 of the respective telescoping arm 22, 24. In the present embodiment, the side structure 26 may include a recess 42 to accommodate the collective width of the stacked arrangement of step pads thereby minimizing or eliminating the amount in which the stacked arrangement of step pads protrudes outwardly from the vehicle 12. Furthermore, the running board assembly 10 may include a concealing member 44 having a flap-like construction and pivotally coupled to the side structure 26 about pivot axis X₄ (FIG. 6), which generally extends longitudinally with respect to the concealing member 44. The concealing member 44 is configured to pivot about pivot axis X₄ between an open position, as shown in FIGS. 5 and 6, and a closed position, as shown in FIG. 7, where the concealing member 44 covers the stacked arrangement of step pads and the telescoping arms 22, 24 and is generally flush with the side structure 26 thereby concealing the step pads and the telescoping arms 22, 24 from observers outside the vehicle 12. When in the closed position, the concealing member 44 also protects the step pads and the telescoping arms 22, 24 against the elements. Accordingly, the general arrangement of the running board assembly 10 in FIG. 7 is referred to herein as the stowed position.

With respect to the embodiments described herein, it is contemplated that movement of the telescopic arms 22, 24 between the retracted and extended positions may be realized through the use of one or more actuators operably coupled thereto and provided on the vehicle 12. Likewise movement of each step pad between the stowed and deployed positions along with movement of the concealing member 44 between the open and closed positions may also be realized through the use of one or more actuators operably coupled thereto and provided on the vehicle 12. The use of actuators for effectuating linear or rotational movement is generally well known in the art. However, it is contemplated that other devices may be used for accomplishing the same.

According to one embodiment, the running board assembly 10 is deployable from the stowed position shown in FIG. 7 to the use position shown in FIGS. 1-4 by first releasing the concealing member 44 from the closed position to the open position. Next, the telescoping arms 22, 24 are moved to the extended position. Finally, the step pads are moved from the undeployed position to the deployed position by downwardly pivoting each step pad about its respective pivot axis until the deployed position is reached. It is contemplated that the step pads may be moved to the deployed position in unison, or alternatively, the step pads may be moved to the deployed position in succession, beginning with the proximate step pad 14 and ending with the distal step pad 16 or vice versa, for example. Alternatively still, it is contemplated that the step pads may each be moved from the undeployed position to the deployed position (in unison or succession) in conjunction with the telescoping arms 22, 24 being moved to the extended position. Yet alternatively still, each of the step pads may be moved from the undeployed position to the deployed position (in unison or succession) prior to moving the telescoping arms 22, 24 to the extended position. In some embodiments, the deployment of the running board assembly 10 from the stowed position to the use position may be conditioned on one or more events taking place. For example, it is contemplated that the running board assembly 10 may be deployed from the stowed position to the use position when one or more doors, such as doors 38 and/or 40 are opened or otherwise unlocked. It is also contemplated that the running board assembly 10 may be deployed from the stowed position to the use position through a user-input device such as a push button provided in the vehicle 12 or on a mobile electronic device such as a key fob or smart device (e.g., smart phone).

According to one embodiment, the running board assembly 10 is returned to the stowed position shown in FIG. 7 from the use position shown in FIGS. 1-4 by first moving the telescoping arms 22, 24 to the retracted position. Next, the step pads are moved from the deployed position to the undeployed position in unison, or alternatively, the step pads are moved from the deployed position to the undeployed position in succession beginning with the proximal step pad 14 and ending with the distal step pad 16, for example. Alternatively still, it is contemplated that the step pads may each be moved from the deployed position to the undeployed position (in unison or succession) in conjunction with the telescoping arms 22, 24 being moved to the retracted position. Yet alternatively still, each of the step pads may be moved from the deployed position to the undeployed position (in unison or succession) prior to moving the telescopic arms 22, 24 to the retracted position. In some embodiments, the return of the running board assembly 10 to the stowed position from the use position may also be conditioned on one or more events taking place. For example, it is contemplated that the running board assembly 10 may be returned to the stowed position from the use position when doors 38 and/or 40 are closed or otherwise locked. It is also contemplated that the running board assembly 10 may be returned to the stowed position from the use position through a user-input device such as a push button provided in the vehicle 12 or on a mobile electronic device.

Accordingly, a running board assembly has been described herein. The running board assembly includes multiple step pads advantageously arranged to enable a user to gradually enter or exit the vehicle. This offers a great benefit for users who lack surefootedness and/or vehicles having high ground clearance.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims as interpreted according to the principles of patent law, including the doctrine of equivalents.

It will be understood by one having ordinary skill in the art that construction of the described disclosure, and other components, is not limited to any specific material. Other exemplary embodiments of the disclosure disclosed herein may be formed from a wide variety of materials, unless described otherwise herein.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature, or may be removable or releasable in nature, unless otherwise stated.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, and the nature or numeral of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes, or steps within described processes, may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further, it is to be understood that such concepts are intended to be covered by the following claims, unless these claims, by their language, expressly state otherwise. Further, the claims, as set forth below, are incorporated into and constitute part of this Detailed Description.

What is claimed is:

1. A running board assembly of a vehicle, comprising:
a deployment mechanism movable between a retracted position and an extended position; and
a plurality of step pads coupled to the deployment mechanism and each movable between an undeployed position and a deployed position.

2. The running board assembly of claim 1, wherein the running board assembly is in a use position when each of the plurality of step pads are in the deployed position and the deployment mechanism is in the extended position.

3. The running board assembly of claim 1, wherein the running board assembly is in a stowed position when each of the plurality of step pads are in the undeployed position and the deployment mechanism is in the retracted position.

4. The running board assembly of claim 1, further comprising a concealing member configured to cover the plurality of step pads and the deployment mechanism when the plurality of step pads are each in the undeployed position and the deployment mechanism is in the retracted position.

5. The running board assembly of claim 1, wherein when the plurality of step pads are each in the deployed position and the deployment mechanism is in the extended position, the plurality of step pads are arranged as a stairway leading up to an entryway of the vehicle.

6. The running board assembly of claim 1, wherein the plurality of step pads comprises a proximal step pad, a distal step pad, and at least one intermediate step pad positioned between the proximal step pad and the distal step pad, wherein when the proximal, distal, and at least one intermediate step pads are each in the deployed position and the deployment mechanism is in the extended position, the proximal step pad is located at a shortest distance to the vehicle, the distal step pad is located at a farthest distance from the vehicle, and the at least one intermediate step pad is located relative to the vehicle at an intermediate distance between the shortest distance and the farthest distance.

7. The running board assembly of claim 1, wherein the plurality of step pads comprises a proximal step pad, a distal step pad, and at least one intermediate step pad positioned between the proximal step pad and the distal step pad, wherein when the proximal, distal, and at least one intermediate step pads are each in the deployed position and the deployment mechanism is in the extended position, the proximal, distal, and at least one intermediate step pads are staggered relative to one another.

8. The running board assembly of claim 1, wherein the plurality of step pads comprises a proximal step pad, a distal step pad, and at least one intermediate step pad positioned between the proximal step pad and the distal step pad, wherein when the proximal, distal, and at least one intermediate step pads are each in the deployed position and the deployment mechanism is in the extended position, the proximal step is located at a farthest distance relative to a ground surface, the distal step pad is located at a shortest distance relative to the ground surface, and the at least one intermediate step pad is located at an intermediate distance relative to the ground surface, the intermediate distance being between the shortest distance and the farthest distance.

9. The running board assembly of claim 1, wherein when the plurality of step pads are each in the undeployed position and the deployment mechanism is in the retracted position, the plurality of step pads collectively define a stacked arrangement where the plurality of step pads are slightly offset from one another.

10. A running board assembly of a vehicle, comprising:
a deployment mechanism movable between a retracted position and an extended position; and
a plurality of step pads coupled to the deployment mechanism and each movable between an undeployed position and a deployed position;
wherein the running board assembly is in a use position when each of the plurality of step pads are in the deployed position and the deployment mechanism is in the extended position; and
wherein the running board assembly is in a stowed position when each of the plurality of step pads are in the undeployed position and the deployment mechanism is in the retracted position.

11. The running board assembly of claim 10, further comprising a concealing member configured to cover the plurality of step pads and the deployment mechanism when the plurality of step pads are each in the undeployed position and the deployment mechanism is in the retracted position.

12. The running board assembly of claim 10, wherein when the plurality of step pads are each in the deployed position and the deployment mechanism is in the extended position, the plurality of step pads are arranged as a stairway leading up to an entryway of the vehicle.

13. The running board assembly of claim 10, wherein the plurality of step pads comprises a proximal step pad, a distal step pad, and at least one intermediate step pad positioned between the proximal step pad and the distal step pad, wherein when the proximal, distal, and at least one intermediate step pads are each in the deployed position and the deployment mechanism is in the extended position, the proximal step pad is located at a shortest distance to the vehicle, the distal step pad is located at a farthest distance from the vehicle, and the at least one intermediate step pad is located relative to the vehicle at an intermediate distance between the shortest distance and the farthest distance.

14. The running board assembly of claim 10, wherein the plurality of step pads comprises a proximal step pad, a distal step pad, and at least one intermediate step pad positioned between the proximal step pad and the distal step pad, wherein when the proximal, distal, and at least one intermediate step pads are each in the deployed position and the deployment mechanism is in the extended position, the proximal, distal, and at least one intermediate step pads are staggered relative to one another.

15. The running board assembly of claim 10, wherein the plurality of step pads comprises a proximal step pad, a distal step pad, and at least one intermediate step pad positioned between the proximal step pad and the distal step pad, wherein when the proximal, distal, and at least one intermediate step pads are each in the deployed position and the deployment mechanism is in the extended position, the proximal step is located at a farthest distance relative to a ground surface, the distal step pad is located at a shortest distance relative to the ground surface, and the at least one intermediate step pad is located at an intermediate distance relative to the ground surface, the intermediate distance being between the shortest distance and the farthest distance.

16. The running board assembly of claim 10, wherein when the plurality of step pads are each in the undeployed position and the deployment mechanism is in the retracted position, the plurality of step pads collectively define a stacked arrangement where the plurality of step pads are slightly offset from one another.

17. A running board assembly of a vehicle, comprising:
a deployment mechanism movable between a retracted position and an extended position; and
a plurality of step pads coupled to the deployment mechanism and each movable between an undeployed position and a deployed position;
wherein when the plurality of step pads are each in the deployed position and the deployment mechanism is in the extended position, the plurality of step pads are arranged as a stairway leading up to an entryway of the vehicle.

18. The running board assembly of claim 17, wherein the deployment mechanism comprises one or more telescoping arms.

19. The running board assembly of claim 17, wherein when the deployment mechanism is in the retracted position and the step pads are in the undeployed position, the deployment mechanism and step pads are stowed in a recess provided on a side structure of the vehicle.

20. The running board assembly of claim 19, further comprising a concealing member pivotally coupled to the side structure for covering the deployment mechanism and step pads and is flush with the side structure.
